(19) United States
(12) Patent Application Publication
(10) Pub. No.: US 2006/0181389 A1
(43) Pub. Date: Aug. 17, 2006

(54) Thin film type resistor and printed circuit board with an embedded thin film resistor and a method for producing the same

(75) Inventor: Shi-Yun Cho, Seoul (KR)

Correspondence Address: CHA & REITER, LLC, 210 ROUTE 4 EAST STE 103, PARAMUS, NJ, 07652, US

(73) Assignee: Samsung Electronics Co.; LTD

(21) Appl. No.: 11/330,543

(22) Filed: Jan. 12, 2006

(30) Foreign Application Priority Data
Feb. 15, 2005 (KR) 2005-12344

(51) Int. Cl. H01C 1/012

(52) U.S. Cl. 338/309

(57) ABSTRACT

A thin film type resistor is disclosed. The thin film type resistor comprises first and second pads, a first resistance layer, and a second resistance layer. The first and second resistance layers are spaced apart from each other. Both ends of a first resistance layer are connected to the first and second pads. A second resistance layer is disposed on the first resistance layer, and has a resistance value different from that of the first resistance layer.

### CLAIM OF PRIORITY

This application claims priority under 35 U.S.C. § 119 to an application entitled “Thin Film Type Resistor and Printed Circuit Board with an Embedded Thin Film Resistor,” filed in the Korean Intellectual Property Office on Feb. 15, 2005 and assigned Serial No. 2005-12344, the contents of which are incorporated herein by reference.

### BACKGROUND OF THE INVENTION

1. Field of the Invention

The present invention relates to a resistor, and more particularly to a thin film type resistor.

2. Description of the Related Art

Generally, modern electronic products are required to perform various functions while maintaining small size. To maintain the small size, the conventional electronic devices provide embedded passive Printed Circuit Boards (PCB) with embedded passive components such as resistors, capacitors, and inductors, etc.

FIG. 1 illustrates such a conventional thin film type resistor. The thin film type resistor 100 is provided with first and second pads 110 and 120, spaced apart from each other, and a resistance layer 130, which contains two ends that are connected to the first and second pads 110 and 120. The resistance value R of the thin film type resistor 100 is defined in Equation (1).

$$R = {R}_{s} \times {A}_{s} = {R}_{s} \times \frac{L}{W} \qquad Equation ( 1 )$$

In Equation (1), Rₛ denotes a sheet resistance value of the resistance layer 130, Aₛ denotes an aspect ratio, L denotes a true length of the resistance layer 130, and W denotes a width of the resistance layer 130. The true length L is obtained by subtracting lengths of parts in contact with the first and second pads 110 and 120 from a total length of the resistance layer 130. That is, the true length L corresponds to an interval between the first and second pads 110 and 120. The aspect ratio Aₛ is a value obtained by dividing the true length L of the resistance layer 130 by the width W.

The thin film type resistor 100 is embedded in the PCB. The thin film type resistor 100 conventionally has a large error of about 20 % because technical limitations exist in the manufacturing process. In particular, the size of the thin film type resistor 100 may deviate from predetermined size during PCB manufacturing process due to alignment error. Alternatively, the size (e.g., length, width, or thickness) may deviate due to errors occurring in a screen printing process for forming the resistance layer 130. Because of the errors occurring in such processes, the resistance value of the thin film type resistor 100 also deviates from the preset value.

To compensate such errors, a laser trimming process is usually performed to conform with the thin film type resistor produced via a screen printing process to the preset design value. Such laser trimming process, however, requires costly laser trimming equipments and PCB process equipments. Therefore, manufacturing conventional thin film type resistors and PCB with an embedded thin film type resistor may involve enormous cost.

As noted above, a typical thin film resistor has a relatively large process error.

Moreover, the process, such as the laser trimming process, to correct the large process error may be costly. Therefore, the manufacturing cost incurred in manufacturing a thin film resistor without a relatively large process error is high. Accordingly, a new method capable of correcting the process error of the thin film type resistor without incurring much cost is required.

### SUMMARY OF THE INVENTION

The present invention has been designed to solve above and other problems occurring in the prior art and provide additional advantages, by providing a thin film type resistor and a printed circuit board (PCB) with an embedded thin film type resistor that is capable of compensating the process error and adjust the resistance value using conventional PCB process equipment, without using additional, costly equipments.

In accordance with an aspect of the present invention, a thin film type resistor is provided. The thin film type resistor comprises: first and second pads spaced apart from each other; a first resistance whose both ends are connected to the first and second pads; and a second resistance layer stacked on the first resistance layer, the second resistance layer having a resistance value different from that of the first resistance layer.

In accordance with another aspect of the present invention, a printed circuit board (PCB) for use in a structure in which a circuit layer with conductivity and a support layer with electrical insulation are alternately stacked is provided. The PCB comprises: at least one thin film type resistor embedded in the PCB, and thin film type resistor comprises at least: first and second pads spaced apart from each other; a first resistance layer whose both ends are connected to the first and second pads; and a second resistance layer stacked on the first resistance layer, the second resistance layer having a resistance value different from that of the first resistance layer.

### BRIEF DESCRIPTION OF THE DRAWINGS

The above features and advantages of the present invention will be more apparent from the following detailed description in conjunction with the accompanying drawings, in which:

FIG. 1 is a plane view illustrating a typical thin film type resistor;

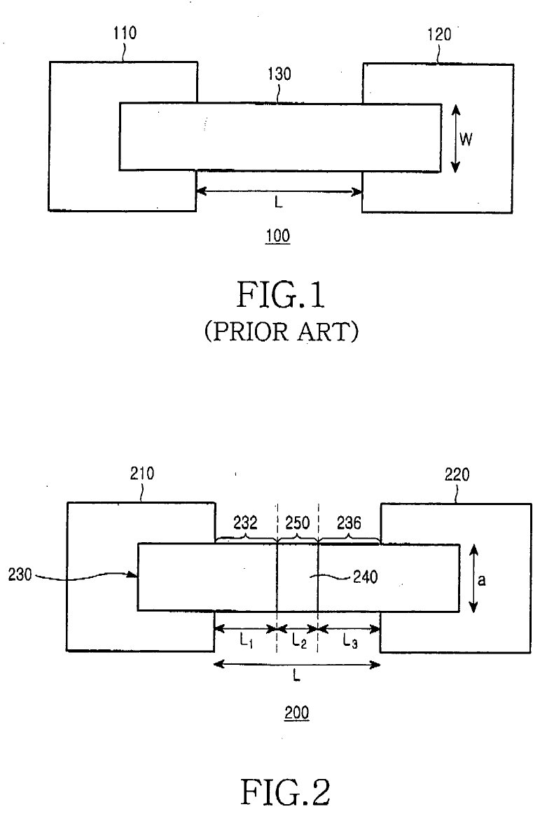

FIG. 2 is a plane view illustrating a thin film type resistor in accordance to an aspect of the present invention;

FIG. 3 is a sectional view illustrating the thin film type resistor illustrated in FIG. 2;

FIG. 4 is a circuit diagram illustrating the thin film type resistor illustrated in FIG. 2; and

FIGS. 5 to 10 are sectional views illustrating a method for fabricating a printed circuit board (PCB) with an embedded thin film type resistor in accordance to another aspect of the present invention.

### DETAILED DESCRIPTION

Several aspects of the present invention will be described in detail with reference to the accompanying drawings. For purposes of clarity and simplicity, detailed descriptions of known functions and configurations are omitted, as they may make the subject matter of the present invention unclear.

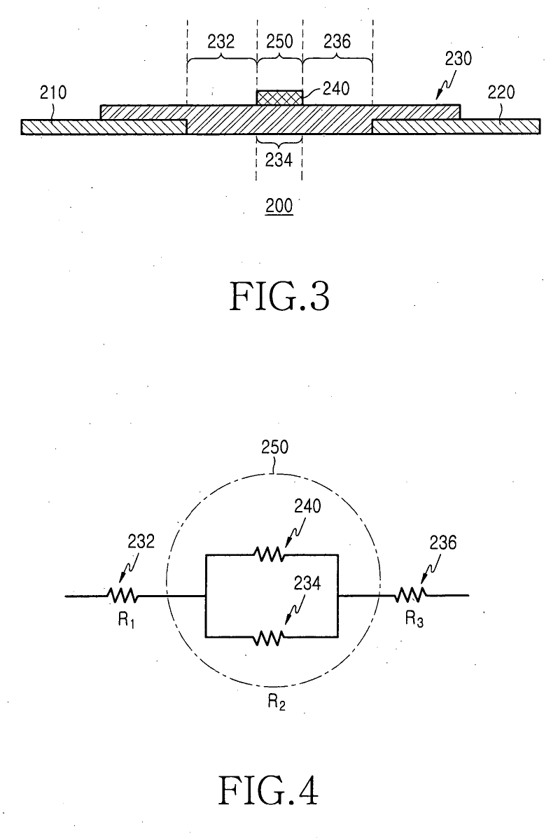

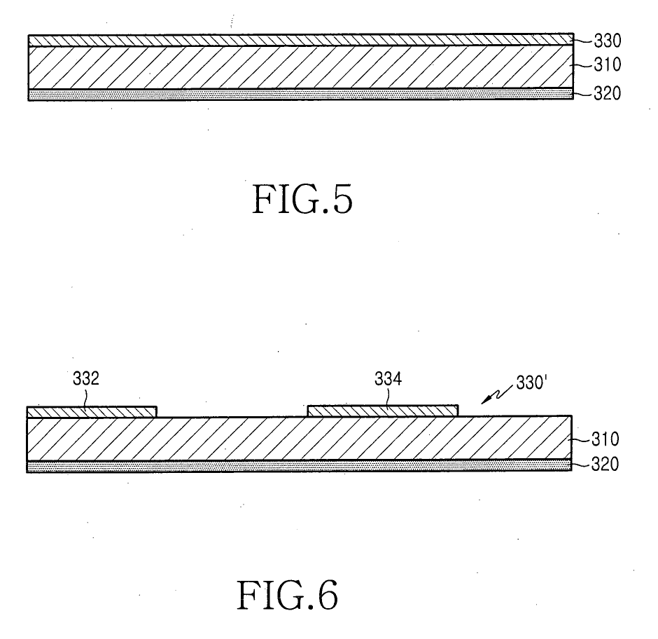

FIG. 2 is a plane view illustrating a thin film type resistor in accordance to one aspect of the present invention, and FIG. 3 is a sectional view illustrating the thin film type resistor illustrated in FIG. 2. The thin film type resistor 200 comprises first and second pads 210 and 220, spaced apart from each other; a first resistance layer 230, whose both ends are connected to the first and second pads 210 and 220; and a second resistance layer 240, disposed on the first resistance layer 230 and having a sheet resistance value different from that of the first resistance layer 230.

The second resistance layer 240 has the same width a as the first resistance layer 230 and disposed on the middle part of the first resistance layer 230, the part that does not contact the first and second pads 210 and 220. Hereinafter, it is assumed that the length is in an electric current flow direction and the width is in a direction perpendicular to the electric current flow direction.

The first resistance layer 230 includes a first resistance part 232, a second resistance part 234, and a third resistance part 236. The second resistance part 234 is in contact with the second resistance layer 240. The first resistance part 232, disposed on one side of the second resistance part 234, is not in contact with the second pad 220. The third resistance part 236, disposed on the other side of the second resistance part 234, is not in contact with the first pad 210.

Therefore, the thin film type resistor 200 includes a first resistance area corresponding to the first resistance part 232, a second resistance area 250 corresponding to the second resistance part 234 and the second resistance layer 240, and a third resistance area corresponding to the third resistance part 236. As the first and third resistance areas are the first and third resistance parts 232 and 236, respectively, the same reference numerals are used.

The first and second pads 210 and 220 are made from conductive materials, such as copper, and can be formed by photolithographic process. The first and second resistance layers 230 and 240 are made from resistive materials, such as carbon, and can be formed by the conventional screen printing process using a polymer thick film (PTF) ink.

If the resistance value of the first resistance layer 230, after the first resistance layer 230 is disposed, differs from the design value, the second resistance layer 240 is provided to compensate the difference. In particular, the resistance value of the second resistance layer 240 is set to compensate the resistance value error of the first resistance layer 230.

The resistance value of the second resistance layer 240 is set such that a resistance value R of the thin film type resistor 200 has a preset value as defined by Equations (2) to (6).
R=R₁+R₂+R₃ Equation (2)

The resistance value R of the thin film type resistor 200 is defined by a sum of the resistance value R₁ of the first resistance area 232, the resistance value R₂ of the second resistance area 250, and the resistance value R₃ of the third resistance area 236.
L=L₁+L₂+L₃ Equation (3)

The true length L of the thin film type resistor 200 is defined as a sum of the length L₁ of the first resistance area 232, the length L₂ of the second resistance area 250, and the length L₃ of the third resistance area 236. The length of the second resistance area 250 is the same as that of the second resistance layer 240. The true length of the thin film type resistor 200 is obtained by subtracting lengths of parts in contact with the first and second pads 210 and 220 from a total length of the first resistance layer 230. That is, the true length of the thin film type resistor 200 corresponds to an interval between the first and second pads 210 and 220.

$${R}_{1} = {Rs}_{1} \times \frac{{L}_{1}}{a} \qquad Equation ( 4 )$$

The resistance of the first resistance area 232 is obtained by multiplying the sheet resistance value Rs₁ of the first resistance layer 230 with the result of the length of the first resistance area 232 divided by the width of the first resistance layer 230.

$$\frac{1}{{R}_{2}} = \frac{a}{{Rs}_{1} \times {L}_{2}} + \frac{a}{{Rs}_{2} \times {L}_{2}} \qquad Equation ( 5 )$$

The reciprocal of the resistance of the second resistance area 250 is a sum of the reciprocal of the resistance of the second resistance part 234 and the reciprocal of the resistance of the second resistance layer 240. The resistance of the second resistance layer 240 is obtained by multiplying the sheet resistance Rs₂ of the second resistance layer 240 with the result of the length of the second resistance area 250 divided by the width of the first resistance layer 230.

$${R}_{3} = {R s}_{1} \times \frac{{L}_{3}}{a} \qquad Equation ( 6 )$$

The resistance of the third resistance area 236 is obtained by multiplying the sheet resistance Rs₁ of the first resistance layer 230 and the result of the length value of the third resistance area 236 divided by the width of the first resistance layer 230.

Accordingly, the resistance value of the thin film type resistor 200 is the sum of the resistance values of the areas 232 and 236, the areas that are not in contact with the first pad 210, the second pad 220, and the second resistance layer 240 disposed on the first resistance layer 230, and a composite resistance value of the area 250, the area formed by the second resistance layer 240 and the part 234 of the first resistance layer 230.

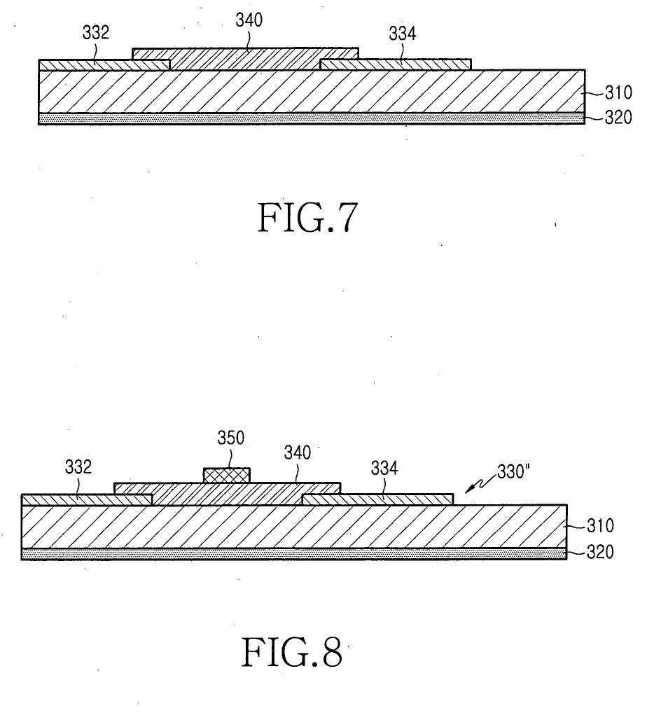

FIG. 4 is a circuit diagram illustrating the thin film type resistor 200. As illustrated in FIG. 4, the thin film type resistor 200 has a structure in which the first to third resistance areas 232, 250, and 236 are coupled in series. The second resistance area 250 has a structure in which the second resistance part 234 and the second resistance layer 240 are coupled in parallel.

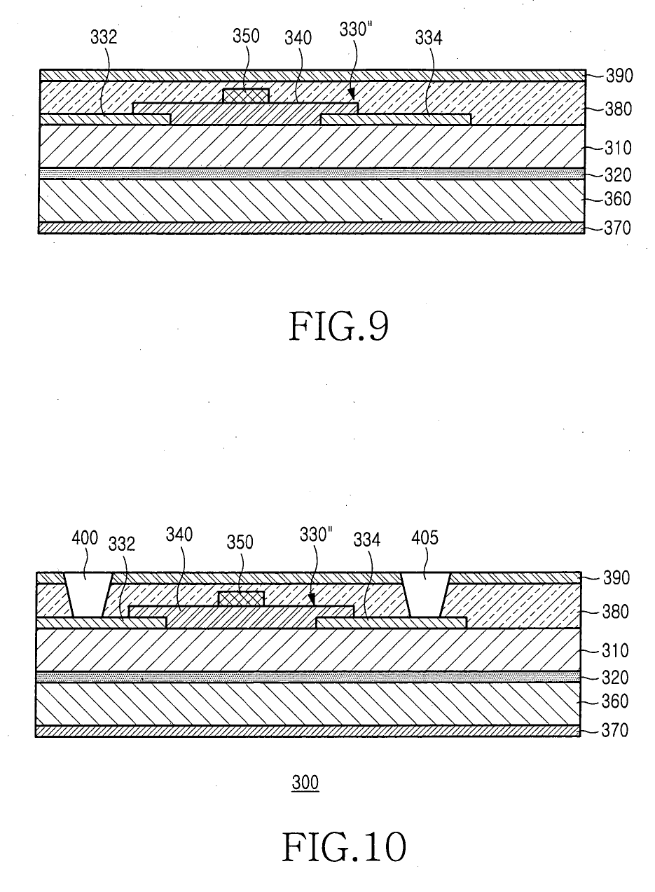

FIGS. 5 to 10 are sectional views illustrating a method for manufacturing a printed circuit board (PCB) with an embedded thin film type resistor in accordance to another aspect of the present invention. The manufacturing method includes first to sixth processes.

In the first process, as illustrated in FIG. 5, the first and second electricity conducting circuit layers 320 and 330 are disposed on upper and lower surfaces of the first electrical insulating support layer 310. The first support layer 310 may comprise a prepreg. The prepreg is made from a semi-cured state in which a thermosetting resin penetrates into a glass fiber. Meanwhile, the first and second circuit layers 320 and 330 may comprise copper. Alternatively, the first support layer 310 and the first and second circuit layers 320 and 330 may comprise Copper Clad Laminate (CCL) provided in a single body.

In the second process, as illustrated in FIG. 6, the second circuit layer 330 is etched according to a preset pattern using photolithographic process. When the second process is performed, a circuit layer 330′, the circuit layer comprising first and second pads 332 and 334 that are spaced apart from each other, is formed.

In the third process, as illustrated in FIG. 7, the first resistance layer 340 is disposed on the first support layer 310 and formed between the first and second pads 332 and 334. The first resistance layer 340 may be formed using a screen printing process such that both ends of the first and second pads 332 and 334, opposite to each other, may be in contact with the first resistance layer 340.

The fourth process comprises identifying a resistance error of the first resistance layer 340 and setting the size and sheet resistance of a second resistance layer 350 using Equations (2) to (6) to compensate for the resistance error. Moreover, as illustrated in FIG. 8, the second resistance layer 350 with the size and sheet resistance set to compensate for the resistance error of the first resistance layer 340 is disposed on the first resistance layer 340.

The first and second pads 332 and 334 and the first and second resistance layers 340 and 350 represents the circuit layer 330″.

In the fifth process, as illustrated in FIG. 9, a second support layer 360 and a third circuit layer 370 are sequentially disposed on the first circuit layer 320, and a third support layer 380 and a fourth circuit layer 390 are sequentially disposed on the circuit layer 330″.

In the sixth process, as illustrated in FIG. 10, first and second holes 400 and 405 are formed. The first and second holes 400 and 405 pass through the fourth circuit layer 390 and the third support layer 380 and reach the first and second pads 332 and 334, such that the fourth circuit layer 390 and the circuit layer 330″ are electrically connected to each other. The first and second holes 400 and 405 are formed by the conventional drilling process.

As noted above, the present invention provides a thin film type resistor and a printed circuit board (PCB) where a second resistance layer, which adjusts the resistance value, is disposed on the first resistance layer having a main resistance value. Such thin film type resistor and printed circuit board compensate a process error using only the conventional PCB process equipment, without using additional, costly equipment such as laser trimming equipments.

What is claimed is:

1. A thin film type resistor, comprising:
first and second pads spaced apart from each other;
a first resistance layer having two ends are coupled to the first and second pads; and
a second resistance layer disposed on the first resistance layer, the second resistance layer having a resistance value different from that of the first resistance layer.

2. The thin film type resistor of claim 1, wherein the second resistance layer has a sheet resistance value different from that of the first resistance layer.

3. The thin film type resistor of claim 1, wherein a resistance value of the thin film type resistor is a sum of (1) resistance values of areas that are not in contact with the first pad, second pad, and the second resistance layer, and (2) a composite resistance value of an area formed by the second resistance layer and a part of the first resistance layer in contact with the second resistance layer, the composite resistance value R₂ being defined by:
$$\frac{1}{{R}_{2}} = \frac{a}{{Rs}_{1} \times {L}_{2}} + \frac{a}{{Rs}_{2} \times {L}_{2}} ,$$
where Rs₁ is a sheet resistance value of the first resistance layer, Rs₂ is a sheet resistance value of the second resistance layer, α is a width value of the second resistance layer, and L₂ is a length value of the second resistance layer.

4. The thin film resistor of claim 1, wherein the second resistance layer is disposed on a portion of the first resistance layer that does not contact the first and second pads.

5. The thin film resistor of claim 1, wherein each pad comprises copper.

6. The thin film resistor of claim 1, wherein the second resistance layer compensates deviation of the resistance value of the first resistance layer from the preset value.

7. A printed circuit board (PCB) for use in a structure in which an electrically conducting circuit layer and an electrically insulating support layer are alternately disposed, the PCB comprising:
at least one thin film type resistor embedded in the PCB, the thin film type resistor comprising at least:
first and second pads spaced apart from each other;
a first resistance layer whose both ends are connected to the first and second pads; and
a second resistance layer disposed on the first resistance layer, the second resistance layer having a resistance value different from that of the first resistance layer.

8. The PCB of claim 7, wherein the second resistance layer has a sheet resistance value different from that of the first resistance layer.

9. The PCB of claim 7, wherein a resistance value of the thin film type resistor is a sum of (1) resistance values of areas that are not in contact with the first pad, second pad, and the second resistance layer, and (2) a composite resistance value of an area formed by the second resistance layer and a part of the first resistance layer in contact with the second resistance layer, the composite resistance value R₂ being defined by:
$$\frac{1}{{R}_{2}} = \frac{a}{{Rs}_{1} \times {L}_{2}} + \frac{a}{{Rs}_{2} \times {L}_{2}} ,$$
where Rs₁ is a sheet resistance value of the first resistance layer, Rs₂ is a sheet resistance value of the second resistance layer, α is a width value of the second resistance layer, and L₂ is a length value of the second resistance layer.

10. The PCB of claim 7 further comprising a plurality of holes for electrically coupling the electrically conducting circuit layer and the thin film type resistor.

11. The PCB of claim 7, wherein the support layer comprises a prepreg.

12. The PCB of claim 7, wherein each pad comprises copper.

13. The PCB of claim 7, wherein the thin film type resistor and the electrically conducting circuit layer are electrically coupled.

14. The PCB of claim 7, wherein the second resistance layer of the thin film type resistor compensates deviation of the resistance value of the first resistance layer from a preset value.

15. A method for producing a printed circuit board (PCB), comprising the steps of:
(a) providing an electrically conducting circuit layer and an electrically insulating support layer alternately; and
(b) providing at least one thin film type resistor by at least
(i) providing first and second pads spaced apart from each other;
(ii) providing a first resistance layer whose both ends are connected to the first and second pads; and
(iii) providing a second resistance layer disposed on the first resistance layer, the second resistance layer having a resistance value different from that of the first resistance layer.

16. The method for producing the PCB of claim 15, wherein the step (i) is provided with a photolithographic process.

17. The method for producing the PCB of claim 15, wherein the steps (ii) and (iii) are provided with a screen printing process using a polymer thick film (PTF) ink.

18. The method for producing a PCB of claim 15, the step (iii) further comprising a step of providing the second resistance layer having a sheet resistance value different from that of the first resistance layer.

19. The method for producing a PCB of claim 15 further comprising a step for providing at least one thin film type resistor having a resistance value that is a sum of (1) resistance values of areas that are not in contact with the first pad, second pad, and the second resistance layer, and (2) a composite resistance value of an area formed by the second resistance layer and a part of the first resistance layer in contact with the second resistance layer, the composite resistance value R₂ being defined by:
$$\frac{1}{{R}_{2}} = \frac{a}{{Rs}_{1} \times {L}_{2}} + \frac{a}{{Rs}_{2} \times {L}_{2}} ,$$
where ^{Rs}^{₁} is a sheet resistance value of the first resistance layer, ^{Rs}^{₂} is a sheet resistance value of the second resistance layer, ^{α} is a width value of the second resistance layer, and ^{L}^{₂} is a length value of the second resistance layer.

20. The method for producing a PCB as claimed in claim 15, the step (b) further comprising:
detecting the resistance error of the first resistance layer; and
setting the size and sheet resistance of the second resistance layer to compensate deviation of the resistance value of the first resistance layer from a predetermined value.
